(19) United States
(12) Patent Application Publication
(10) Pub. No.: US 2013/0073275 A1
(43) Pub. Date: Mar. 21, 2013

(54) EMULATOR AND MULTI-PROCESSOR SYSTEM

(71) Applicant: Kazuo USUI, Tokyo (JP)

(72) Inventor: Kazuo USUI, Tokyo (JP)

(73) Assignee: RENESAS ELECTRONICS CORPORATION

(21) Appl. No.: 13/609,211

(22) Filed: Sep. 10, 2012

(30) Foreign Application Priority Data
Sep. 15, 2011 (JP) 2011-201681

(51) Int. Cl. G06F 9/455

(52) U.S. Cl. 703/24

(57) ABSTRACT

An emulator is provided which can enhance the efficiency of setup change of operating conditions for a peripheral circuit of a slave processor by a master processor. The emulator comprises a master processor and a slave processor which configure an emulation processor. The slave processor comprises a predetermined peripheral circuit. In a break state, the slave processor receives control data and a first command from the master processor via a first communication path, and stores the control data in a predetermined storage area according to the first command. When the master processor executes a target program to perform function setup of the predetermined peripheral circuit, the master processor issues a second command to the slave processor via the first communication path, and the slave processor executes the first evaluation control program to set the control data specified by the second command to the peripheral circuit from the storage area.

### CROSS-REFERENCE TO RELATED APPLICATIONS

The disclosure of Japanese Patent Application No. 2011-201681 filed on Sep. 15, 2011 including the specification, drawings and abstract is incorporated herein by reference in its entirety.

### BACKGROUND

The present invention relates to an emulator which employs plural processors as an emulation processor and also to a multi-processor system, and in particular relates to technology which is effective when applied to an emulator in which an emulation processor is comprised of an FPGA (Field Programmable Gate Array)-based semiconductor integrated circuit and a real chip, for example.

An emulator is employed in order to support system debugging in a micro-processor application system under development. An emulator is coupled to a micro-processor application system (target system) as a target of the system debugging. An emulation processor on the emulator executes sequentially a program in the developmental stage or a program as an evaluation target (a target program) and controls the target system. In order to verify later the operating state of the target system which is operated by the target program, data, control information, etc. at the time are successively stored in a trace memory, etc.

Due to the nature of controlling the target system as an alternative, the emulation processor is required to be provided with a CPU and a peripheral function which are equivalent to a micro-processor (target processor) to be mounted primarily in the target system, and furthermore required to be provided with an interface necessary for successive execution of the target program and for control of the information trace, etc. Accordingly, the emulation processor will be provided separately from a real chip which serves as the target processor. In that case, even if the CPU is the same, when the micro-processor is one in the family development with different peripheral functions, the emulation processor needs to be provided for each kind of the family. When one tries to provide an emulation processor with the use of a semiconductor integrated circuit of a single chip in analogy with a real chip, it is difficult to provide an evaluation environment quickly, in addition, the cost for realizing the evaluation environment goes up significantly.

Therefore, if an emulation processor is comprised of an FPGA-based semiconductor integrated circuit as disclosed by Patent Literature 1, it becomes possible to define necessary logic according to storage information written in a nonvolatile storage circuit. Patent Literature 2 discloses technology in which the initial state of an emulation processor can be selected by mode setting using a command to a mode register, thereby dealing with a specification change. Patent Literature 3 discloses technology in which an emulation processor is enabled to select an operation mode of a real chip, such as a single chip mode and a ROM-less mode, in addition to an emulation mode, by means of an operation mode signal.
(Patent Literature 1) Japanese Patent Laid-open No. 2010-231607
(Patent Literature 2) Japanese Patent Laid-open No. 2001-101027
(Patent Literature 3) Japanese Patent Laid-open No. 2000-293397

### SUMMARY

However, it has been clarified that there occur some cases which cannot be dealt with by any of the technologies disclosed by the patent literatures described above, when the family development of a peripheral circuit is broad. For example, neither mode setting nor an FPGA can fully support an analog system circuit such as an RF (Radio Frequency) circuit or an SWP (Single Wire Protocol) circuit.

Accordingly, the present inventors carried out a study on configuring an emulation processor with the combined use of a real chip to support an individual peripheral circuit represented by the analog system. That is, an FPGA-based semiconductor integrated circuit is employed for defining a CPU core and a main digital peripheral circuit, and a real chip is diverted to an individual peripheral circuit represented by an analog system circuit. In this case, what is necessary for the real chip is just to prepare in advance an operation mode which enables a specific peripheral circuit alone to interface with the exterior.

However, in the case of system debugging, it is assumed that a peripheral circuit is operated by frequently changing various operating conditions, such as a transfer rate, an operating frequency, the number of parallel transfer bits, etc. In this case, whenever the setup change of the operating conditions is performed, it is necessary to transfer a lot of setup data to a peripheral circuit of another chip via the FPGA-based semiconductor integrated circuit. Accordingly, it is expected that efficiency of the system debugging falls markedly. This point is equivalent to the situation that the setup change of the operating conditions for the interior of another micro-processor by one micro-processor in a multi-processor system is delayed because of the accompanied inter-chip data transfer.

The present invention has been made in view of the above circumstances and provides an emulator which can enhance the efficiency of setup change of operating conditions for a peripheral circuit of a slave processor by a master processor for emulation.

Another purpose of the present invention is to enhance the efficiency of setup change of operating conditions for the interior of another micro-processor by one micro-processor in a multi-processor system.

The above and other purposes and new features will become clear from description of the specification and the accompanying drawings of the present invention.

The following explains briefly an outline of typical inventions to be disclosed by the present application.

That is, an emulator comprises a master processor and a slave processor for configuring an emulation processor. The slave processor comprises a predetermined peripheral circuit which is not provided in the master processor. In a break state, the slave processor receives control data and a first command from the master processor via a first communication path, and stores the control data in a predetermined storage area according to the first command. The master processor issues a second command to the slave processor via the first communication path, when executing a target program to perform function setup of the predetermined peripheral circuit. The slave processor executes the first evaluation control program to set up control data specified by the second command to the peripheral circuit from the storage area. Accordingly, the master processor can use the predetermined peripheral circuit where the control data has been set up according to the target program, via a second communication path.

The following explains briefly an effect obtained by the typical inventions to be disclosed in the present application.

That is, it is possible to enhance the efficiency of the setup change of the operating conditions for the peripheral circuit of the slave processor by the emulation master processor. In other words, it is possible to enhance the efficiency of the setup change of operating conditions for the interior of another micro-processor by one micro-processor in a multi-processor system.

### BRIEF DESCRIPTION OF THE DRAWINGS

FIG. 1 is a block diagram illustrating a configuration of an emulator according to one embodiment of the present invention;

FIG. 2 is an explanatory diagram illustrating a state where peripheral function of a radio frequency communication interface circuit is selected in a slave processor;

FIG. 3 is an explanatory diagram illustrating a state where peripheral function of an SWP communication interface circuit is selected in the slave processor;

FIG. 4 is an explanatory diagram illustrating an outline of an emulator in which a slave processor assigned with peripheral function of an RFMDL and a slave processor assigned with peripheral function of an SWPMDL are presented separately;

FIG. 5 is a flow chart illustrating operation in a break state and an emulation state of the emulator;

FIG. 6 is an explanatory diagram illustrating schematically operation of generating a set command of control data and setting the control data to a radio frequency communication interface circuit from a RAM;

FIG. 7 is a block diagram illustrating another coupling configuration of a slave processor and a master processor in the emulator; and

FIG. 8 is a block diagram illustrating a configuration of a multi-processor system according to another embodiment of the present invention.

### DETAILED DESCRIPTION

### 1. Outline of Embodiments

First, an outline of a typical embodiment of the invention disclosed in the present application is explained. A numerical symbol of the drawing referred to in parentheses in the outline explanation about the typical embodiment only illustrates what is included in the concept of the component to which the numerical symbol is attached.

(1) <An Emulator Employing a Target Processor of a Master-Slave Type>

An emulator (1, 1_{—}a) according to a typical embodiment of the present invention comprises an emulator controller (22) interfaced with a host device, and a master processor (20) and a slave processor (30) for configuring an emulation processor coupled to the emulator controller. The slave processor comprises a peripheral circuit (306, 307) which is not provided in the master processor. By executing a first evaluation control program (FW), the slave processor receives control data and a first command via a first communication path (51), from the master processor which executes a second evaluation control program (EFW) in a break state, and stores the control data in a predetermined storage area (301) according to the first command. The master processor issues a second command to the slave processor via the first communication path, when executing a target program (TPGM) to perform function setup of the peripheral circuit (307). By executing the first evaluation control program, the slave processor sets up control data specified by the second command, to the peripheral circuit from the storage area. The master processor executes the target program and uses the peripheral circuit set up with the control data, via a second communication path (52).

Accordingly, the control data utilized for a setup of the predetermined peripheral circuit is transferred to the slave processor in advance in the break state, and when the master processor executes processing for changing the operating conditions of the peripheral circuit in the emulation operation state in which a target program is executed, the slave processor responding to this selects the corresponding control data from a storage area, and sets it to the predetermined peripheral circuit. Accordingly, the setup operation does not involve the interprocessor transfer of the control data from the master processor to the slave processor. Therefore, it is possible to enhance the efficiency of the setup change of the operating conditions for the peripheral circuit of the slave processor by the emulation master processor.

(2) <An FPGA>

In Paragraph 1, the master processor is comprised of a first CPU (200) for realizing a necessary program control function and an FPGA-based semiconductor integrated circuit with logical function to be controlled by the first CPU being set reconfigurably.

According to the present configuration, it is possible to support quickly the change of the peripheral circuit in the emulation processor.

(3) <A Real Chip>

In Paragraph 2, the slave processor is a single-chip semiconductor processor comprised of a second CPU (302) having identical function as the first CPU of the master processor, and with the predetermined peripheral circuit (306, 307).

Accordingly, it is possible to provide easily a peripheral circuit necessary for the emulation processor by diverting a real chip.

(4) <Evaluation Interface Mode>

In Paragraph 1, the slave processor has an evaluation interface mode which makes the peripheral circuit accessible from the exterior of the slave processor via the second communication path.

Accordingly, the peripheral circuit of the real chip can be easily utilized as a peripheral circuit of an emulation microcomputer by setting up the evaluation interface mode.

(5) <A Mode Register of Evaluation Interface Mode>

In Paragraph 4, the emulator comprises a mode register (FEML) for setting up the evaluation interface mode. The master processor issues setup data and a third command to the slave processor via the first communication path, when setting up the mode register by means of the second evaluation control program, and the slave processor executes the first evaluation control program to set the setup data specified by the third command to the mode register.

Accordingly, in the break state, the evaluation interface mode can be easily set to the slave processor by the master processor.

(6) <Selection of a Peripheral Circuit>

In Paragraph 4, the slave processor comprises plural peripheral circuits (306, 307), and one of the peripheral circuits selected is made accessible from the exterior of the slave processor in the evaluation interface mode.

Accordingly, it is possible to employ one of plural peripheral circuits provided in the slave processor as a peripheral circuit of the master processor.

(7) <Selection According to a State of an External Terminal>

In Paragraph 6, the slave processor selects a program to be executed at the time of cancelation of a reset, according to a state of a predetermined external terminal (P1, P2, P3). A first state of the external terminal is a state of instructing execution of a program for employing one peripheral circuit in the first evaluation control program. Accordingly, it is possible to easily realize the program execution state by the first evaluation control program which controls one peripheral circuit employed in the evaluation interface mode, with the aid of terminal processing to the predetermined external terminal.

(8) <An NFC Interface Circuit and an SWP Interface Circuit>

In Paragraph 6, the slave processor comprises, as the peripheral circuit, a first communication interface circuit (307) for performing proximity non-contact communication (near field communication) through an antenna coupled externally, and a second communication interface circuit (306) for interfacing the first communication interface circuit with an IC card microcomputer by means of a single wire protocol.

Accordingly, it is possible to easily support debugging to the system using the single wire protocol interface which interfaces the interface of the proximity non-contact communication with a microcomputer for IC cards.

(9) <Automatic Generation of the Second Command>

In Paragraph 1, the master processor comprises a first CPU (200) for executing the second evaluation control program and the target program, a first interface circuit coupled to the first communication path, and a command generating circuit (209). The command generating circuit (209) generates the second command in response to the data processing performed by the first CPU for function setup of the predetermined peripheral circuit by executing the target program, and outputs the generated second command to the first communication path from the first interface circuit. The slave processor comprises a second CPU (302) for executing the first evaluation control program, and a second interface circuit (304) coupled to the first communication path. The second CPU executes the first evaluation control program to perform the data processing for responding a command received in the second interface circuit.

Accordingly, it is possible to make the slave processor automatically control the operation that the master processor sets the control data to a predetermined peripheral circuit in the executing state of the target program. Here, the control data has been transferred to the slave processor in advance in order to be utilized for the setup of the predetermined peripheral circuit. The operation does not disturb nor impose burden on the executing state of the target program by the master processor.

(10) <Rewrite of a Program>

In Paragraph 9, the master processor comprises a nonvolatile memory (203) for holding the second evaluation control program in a rewritable manner, and a volatile memory (207) for holding the target program in a rewritable manner. The slave processor comprises a nonvolatile memory (305) for holding the first evaluation control program in a rewritable manner.

Accordingly, it is possible to easily support version upgrade and bug patch of the first evaluation control program and the second evaluation control program.

(11) <Plural Slave Processors>

In Paragraph 1, the emulator comprises plural slave processors (30_1, 30_2, 30_{—}a, 30_{—}b, 30_{—}c). Each of the slave processors executes a respectively unique first evaluation control program, and is controlled by the master processor which executes the second evaluation control program and the target program.

According to the present configuration, it is possible to realize the emulation processor by preparing plural predetermined peripheral circuits for every individual slave processor. Therefore, even when a real chip as a slave processor which mounts plural predetermined peripheral circuits in one chip is not prepared or when such a real chip is prepared, it becomes possible to take the measures by the individual slave processor for each peripheral circuit in cases where there are restrictions of the number of external terminals such that it is difficult to secure external terminals or input/output ports to which the second communication path can be assigned for each predetermined peripheral circuit.

(12) <Peripheral Function Setup in a Multi-Processor System>

A multi-processor system according to another embodiment of the present invention comprises a first processor (20_b) which executes a first program (PGM1) and a second program (PGM2), and a second processor (30_d, 30_{—}e, 30_{—}f) which is provided with a predetermined peripheral circuit (313, 314, 315) and executes a third program (PGM3d, PGM3e, PGM3f). The second processor executes the third program to receive control data and a first command from the first processor executing the first program, via a first communication path (51), and stores the control data in a predetermined storage area (401) according to the first command. The first processor issues a second command to the second processor via the first communication path, when performing function setup of the predetermined peripheral circuit by means of the second program, and the second processor executes the third program to set the control data specified by the second command to the peripheral circuit from the storage area. The first processor uses the predetermined peripheral circuit with the control data set up via a second communication path (52) by means of the second program.

Accordingly, the first processor transfers the control data to be utilized for the setup of the predetermined peripheral circuit to the second processor in advance in the control operating state in which the first program is executed, and when the first processor executes processing for changing the operating conditions of the peripheral circuit in the system operating state in which the second program is executed, the second processor responding to this selects the corresponding control data from the storage area, and sets it to the predetermined peripheral circuit. Accordingly, the setup operation does not involve the interprocessor transfer of the control data from the first processor to the second processor. Therefore, it is possible to enhance the efficiency of the setup change of the operating conditions for the peripheral circuit of the second processor by the first processor, in the system operating state. In other words, it is possible to enhance the efficiency of the setup change of operating conditions for the interior of another micro-processor by one micro-processor in a multi-processor system.

(13) <Automatic Generation of the Second Command>

In Paragraph 12, the first processor comprises a first CPU for executing the first program and the second program, a first interface circuit coupled to the first communication path, and a command generating circuit (209b). The command generating circuit (209b) generates the second command in response to the data processing performed by the first CPU for function setup of the predetermined peripheral circuit by executing the second program, and outputs the generated second command to the first communication path from the first interface circuit. The master processor comprises a second CPU for executing the third program and a second interface circuit coupled to the first communication path. The second CPU executes the third program to perform the data processing for responding a command received in the second interface circuit.

Accordingly, it is possible to make the second processor automatically control the operation for setting the control data to the predetermined peripheral circuit, in the system operating state when the first processor executes the second program. Here, the control data has been transferred to the second processor in advance in order to be utilized for a setup of the predetermined peripheral circuit. The operation does not disturb nor impose burden on the executing state of the second program by the first processor.

(14) <Rewrite of a Program>

In Paragraph 13, the first processor comprises a nonvolatile memory for holding the first evaluation control program in a rewritable manner. The second processor comprises a nonvolatile memory for holding the third program in a rewritable manner. Accordingly, it is possible to easily support version upgrade and bug patch of the first program and the second program.

(15) <Plural Pieces of the Second Processors>

In Paragraph 12, the multi-processor system comprises plural pieces of the second processors. Each of the second processors executes a respectively unique third program and is controlled by the first processor which executes the first program and the second program.

According to the present configuration, it is possible to realize the multi-processor system by preparing plural predetermined peripheral circuits for every individual second processor.

### 2. Details of Embodiments

The embodiments are further explained in full detail.

### Embodiment 1

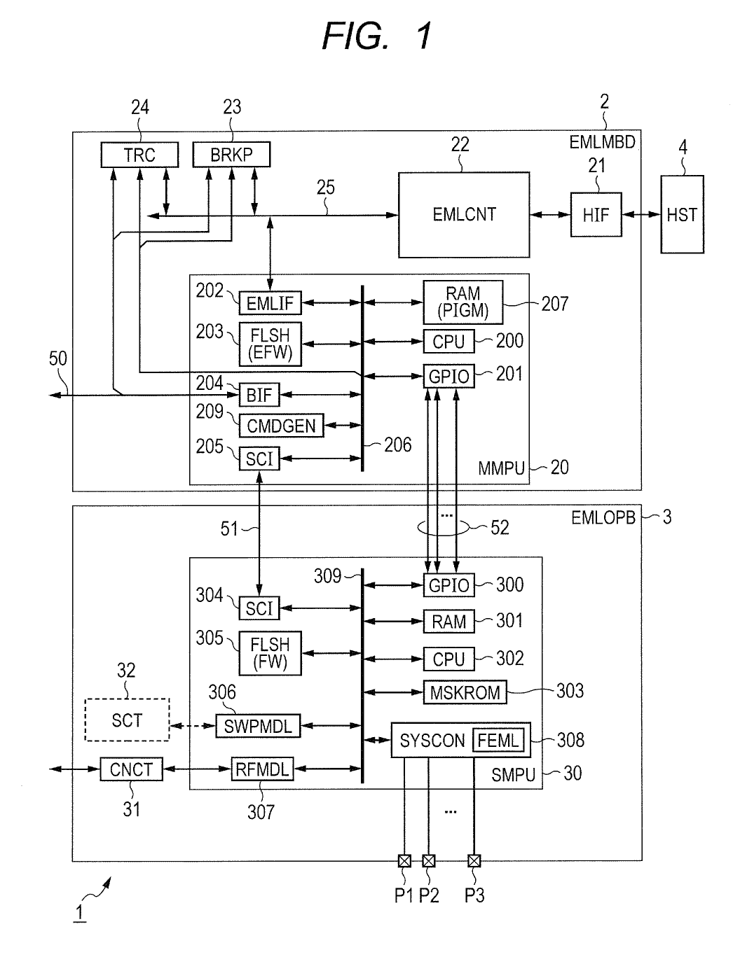

FIG. 1 illustrates a configuration of an emulator according to one embodiment of the present invention.

The emulator 1 illustrated in FIG. 1 is comprised of an emulator main body (EMLMBD) 2 and an option board (EMLOPB) 3. The option board 3 is provided corresponding to a target system as an emulation target. The emulator main body 2 is interfaced with and controlled by a host device (HST) 4, such as a personal computer.

The emulator main body 2 is coupled to an emulator controller (ELMCNT) 22 via a host interface circuit (HIF) 21. The emulator controller 22 controls a trace circuit 24, a break control circuit 23, and a master processor (MMPU) 20, according to instructions from the host device 4. The option board 3 comprises a slave processor (SMCU) 30 coupled to the master processor 20, a connector 31, and a socket 32; the connector 31 and the socket 32 are provided for coupling a target system to the slave processor 30. FIG. 1 illustrates only one slave processor 30 representatively. In fact, however, it should be understood that two pieces of the slave processors are stacked in the direction perpendicular to the surface of FIG. 1. The reason will be mentioned later.

In the emulator 1 illustrated in FIG. 1, an emulation processor, which realizes the control function of a target processor (not shown) adopted for controlling the target system and the support control function for the emulation, is comprised of the master processor 20 of the emulator main body 2 and the slave processor 30 of the option board 3. The slave processor 30 has a circuit configuration so as to realize peripheral function which the master processor 20 does not support. Therefore, if the function of the emulation processor can be realized only by the master processor 20, the option board 3 does not need to be coupled.

Here, the master processor 20 is realized with the use of an FPGA-based semiconductor device. In the FPGA-based semiconductor device, a necessary digital logic is reconfigurable corresponding to write-in data to a large number of nonvolatile memory elements. Therefore, when it is within the range of a digital circuit, the FPGA-based semiconductor device can support various kinds of micro-processors in the family development with the same CPU but with different peripheral functions. The slave processor 30 is employed in order to realize analog system peripheral function, etc. which cannot be supported by the master processor 20. In consideration of realizing such a peripheral function easily in particular, the present embodiment is devised such that a real chip as a target processor can be diverted to the slave processor 30. The following explains in detail a configuration in which the master processor 20 and the slave processor 30 realize the function as the emulation processor.

The master processor 20 comprises a CPU (central processing unit) 200, a RAM 207 as a rewritable volatile memory, a general-purpose input/output port (GPIO) 201 illustrated representatively, an emulation interface (EMLIF) 202, a flash memory (FLSH) 203 as an example of an electrically rewritable nonvolatile memory, a bus interface circuit 204, a serial interface circuit (SCI) 205 illustrated representatively, a command generating circuit (CMDGEN) 209, and an internal bus 206 illustrated generically. The logical function of these circuits is equivalent to the function of a target processor, with respect to the control function to the target system. With respect to the support function of the emulation operation among the logical function of these circuits, the following function is embodied. That is, the emulation interface circuit 202 couples the master processor 20 to the emulation control bus 25, the serial interface circuit (SCI) 205 is coupled to the slave processor 30 via a first communication path 51, the command generating circuit 209 generates automatically a command for internal state setup of the slave processor 30, and the general-purpose input/output port 201 is coupled to the slave processor 30 via a second communication path 52. As the support function of the emulation operation, the internal bus 206 can be referenced from the trace circuit 24 and the break control circuit 23. The bus interface circuit 204 is coupled to the target system via a system bus 50, when necessary. In that case, the system bus 50 can also be referenced from the trace circuit 24 and the break control circuit 23.

The slave processor 30 comprises a general-purpose input/output port (GPIO) 300 illustrated representatively, a RAM 301 as a rewritable volatile memory, a CPU 302, a mask ROM 303, a serial interface circuit (SCI) 304 illustrated representatively, a flash memory (FLSH) 305 as an example of an electrically rewritable nonvolatile memory, a system controller (SYSCON) 308, a radio frequency communication interface circuit (RFMDL) 307 for proximity non-contact communication, as one of analog system peripheral circuits, an SWP communication interface circuit (SWPMDL) 306 by the single wire protocol as another one of the analog system peripheral circuits, and an internal bus 309 illustrated generically.

The radio frequency communication interface circuit 307 performs interface operation for proximity non-contact communication via an antenna board coupled to the antenna connector (CNCT) 31. The SWP communication interface circuit 306 performs interface control between one predetermined terminal of a microcomputer of an IC card mounted in the socket (SCT) 32 and the radio frequency communication interface circuit 307, by means of the single wire protocol.

Assuming in advance that the slave processor 30 as a real chip is to be diverted to the emulator, the slave processor 30 has an evaluation interface mode which allows access to selected one of the radio frequency communication interface circuit 307 and the SWP communication interface circuit 306, from the exterior of the slave processor 30, using the predetermined general-purpose input/output port 300. The setup of the evaluation interface mode is performed by the CPU 302 setting a flag FEML of the system controller 308. Which of the radio frequency communication interface circuit 307 and the SWP communication interface circuit 306 is made accessible in the evaluation interface mode is determined by the slave processor 30 selecting a program to be executed at the time of cancelation of a reset, according to the state of external terminals P1, P2, and P3, for example. In other words, it is supposed that the state of the external terminals P1, P2, and P3 at the time of cancelation of a reset in the slave processor 30 is equivalent to the state of instructing the start of execution of a program for employing one necessary peripheral circuit (the radio frequency communication interface circuit 307 or the SWP communication interface circuit 306 in the present case) in the first evaluation control program FW.

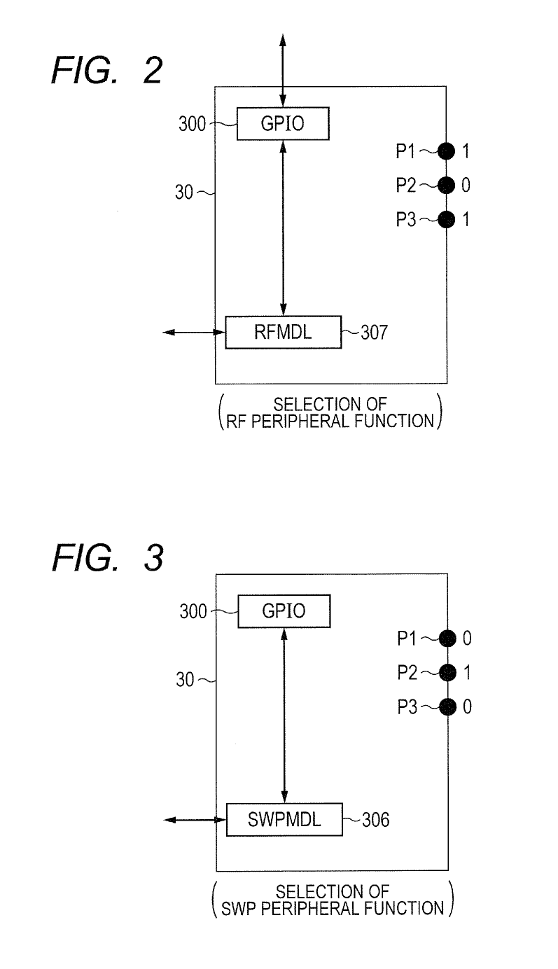

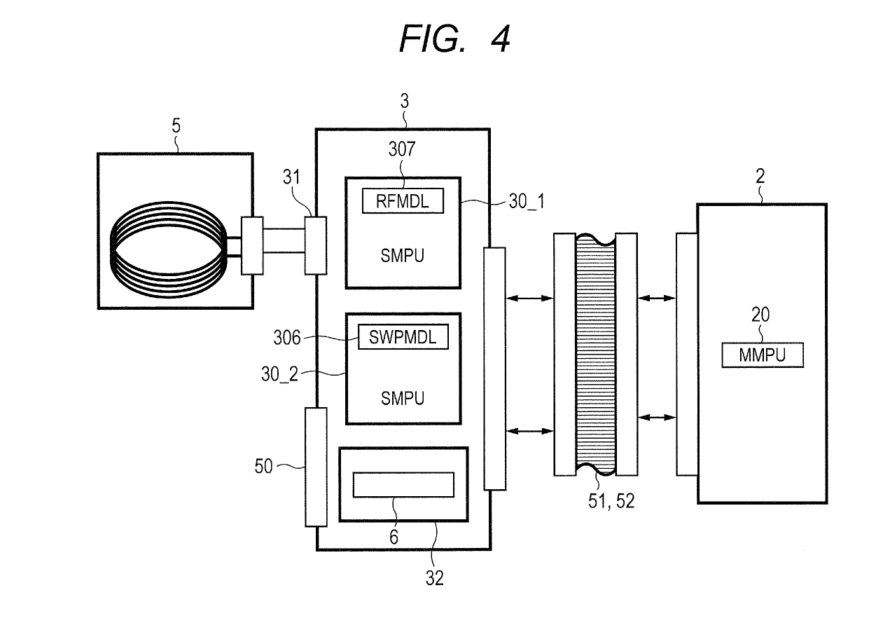

FIG. 2 illustrates a state where peripheral function of the radio frequency communication interface circuit 307 is selected in the slave processor 30. FIG. 3 illustrates a state where peripheral function of the SWP communication interface circuit 306 is selected in the slave processor 30. It is explained in the above that, in FIG. 1, two pieces of the slave processors 30 are stacked actually in the direction perpendicular to the surface of the figure. Specifically, the slave processor 30 in the selected state of the peripheral function illustrated in FIG. 2 and the slave processor 30 in the selected state of the peripheral function illustrated in FIG. 3 are both arranged. The example of application in which the emulation interface mode is set up assigning one peripheral function to one slave processor in this way is not restrictive in particular, but reflects the consideration of the fact that there is no margin in the number of the external terminal or the general-purpose input/output ports 300 for interfacing with the master processor 20, and that it is difficult to interface plural peripheral circuits in one slave processor 30 with the master processor 20 exclusively with an individual interface. The target system assumed by the emulator 1 according to the present embodiment is a mobile-phone and an IC card in which an IC card microcomputer for a user authentication, etc. is mounted and proximity non-contact communication is possible. The present emulator 1 enables system debugging when the user authentication, etc. is performed by the IC card microcomputer via proximity non-contact communication in the target system. FIG. 4 illustrates the configuration of the emulator to explain the state so as to be understood easily. Here, two slave processors 30_1 and 30_2 are illustrated. An antenna board 5 is coupled to the antenna connector 31. A SIM (Subscriber Identity Module Card) 6 provided with an IC card microcomputer is inserted into the socket 32.

The master processor 20 executes a target program TPGM of the system debugging target as the control function to the target system, and executes a second evaluation control program EFW as the support function of the emulation operation. The executing state of the target program by the master processor 20 is called an emulation operation state, and the executable state or executing state of the second evaluation control program EFW by the master processor 20 is called a break state. The target program TPGM is downloaded by the emulator controller 22 from the host device 4, and the downloaded target program TPGM is given to the emulation interface circuit 202 by the emulator controller 22. The master processor 20 stores the target program TPGM in the RAM 301 according to the second evaluation control program EFW in the break state. The second evaluation control program EFW is stored in the flash memory 203, for example.

The second evaluation control program EFW furthermore controls transferring the data and command for control to the slave processor 30 via the serial interface circuit 205. The transfer control by the second evaluation control program EFW includes the followings, for example: firstly, the control of transferring a set command to a flag FEML from the serial interface circuit 205 to the serial interface circuit 304 of the slave processor 30; secondly, in the emulation operation, the operation of transferring in advance the control data for various kinds of initial setting to be set to the radio frequency communication interface circuit 307 or the SWP communication interface circuit 306, from the serial interface circuit 205 to the serial interface circuit 304 of the slave processor 30, and the operation of transferring a storing command for instructing the slave processor to store the control data; and thirdly, in the emulation operation, the control of transferring a set command generated by the command generating circuit 209 from the serial interface circuit 205 to the serial interface circuit 304 of the slave processor 30, in conjunction with the data processing for employing the radio frequency communication interface circuit 307 or the SWP communication interface circuit 306.

The slave processor 3 holds the first evaluation control program FW in the flash memory 305. According to the first evaluation control program FW, the CPU 302 decodes the command supplied to the serial interface 304 and performs data processing, etc., according to the decoded result. That is, firstly, in response to a set command to the flag FEML, the CPU 302 sets the evaluation interface mode to the slave processor 30. Secondly, in response to a storing command of the control data, the CPU 302 performs operation of storing the control data in a predetermined memory area of the RAM 301 sequentially, thereby forming a table of the control data. Thirdly, in response to a set command of the control data, the CPU 302 performs operation of setting the control data from a table address of the RAM 301 indicated by the command to a register address of the peripheral circuit indicated by the command. Although not limited in particular, the storing command of the control data is assigned with a different command code as to the control data for the radio frequency communication interface circuit 307 and as to the control data for the SWP communication interface circuit 306. Accordingly, the destination address of the control data is determined by the command code. Also the set command of the control data is assigned with a different command code as to the initial setting of the control data to the radio frequency communication interface circuit 307 and as to the initial setting of the control data to the SWP communication interface circuit 306. Accordingly, the register address for the initial setting of the control data is determined by the command code.

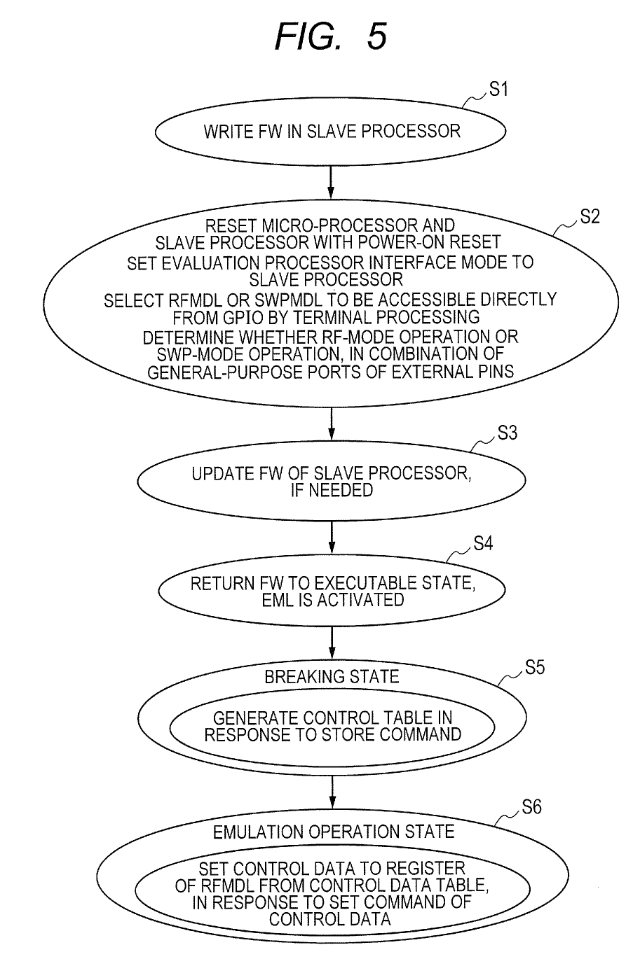

FIG. 5 illustrates an operation flow chart of the emulator 1.

To the master processor 20, the second evaluation control program EFW is downloaded from the host device 4 by the emulator controller 22, as is the case for the target program TPGM. The first evaluation control program FW of the slave processors 30_1 and 30_2 is written in the flash memory, etc. in advance (S1).

Next, the emulator controller 22 is activated and the emulator controller 22 performs the power-on reset to the master processor 20 and the slave processors 30_1, and 30_2. Accordingly, the master processor 20 is enabled to execute the second evaluation control program EFW, the slave processors 30_1 and 30_2 are enabled to execute the first evaluation control program FW, and the emulator enters in the break state. In particular when the reset instruction of the power-on reset to the two slave processors 30 is canceled, the execution state is selected to a program for employing one necessary peripheral circuit for debugging among the first evaluation control program FW, corresponding to the state of the terminal processing to the external terminals P1, P2, and P3. In the example illustrated in FIG. 4, execution of a program for controlling the radio frequency communication interface circuit 307 for use in debugging among the first evaluation control program FW is selected for one slave processor 30_1, and execution of a program for controlling the SWP communication interface circuit 306 for use in debugging among the first evaluation control program FW is selected for the other slave processor 30_2. The CPU 260 issues a set command to the flag FEML from the SCI 205, and the slave processors 30_1 and 30_2 receive the set command at the SCI 304, and make the flag FEML a set state in response to the set command. Accordingly, the master processor 20 is enabled to access the radio frequency communication interface circuit 307 of the slave processor 30_1 from the GPIO 201 via the second communication path 52, and to access the SWP communication interface circuit 306 of the slave processor 30_2 from the GPIO 201 via the second communication path 52 (S2).

Here, when it is necessary to update the first evaluation control program FW, the CPU 200 issues a rewrite command and rewrite data to the flash memory 305 via the SCI 205. In response to this, the CPU 302 executes a rewrite control program to the flash memory 305 held by the mask ROM 303, and rewrites the first evaluation control program FW (S3). After the completion of the rewrite, the CPU 302 restores the first evaluation control program FW updated to the executable state (S4).

Next, in the break state, the CPU 200 transfers in advance the control data for various kinds of initial setting to be set to the radio frequency communication interface circuit 307 in the emulation operation, from the serial interface circuit 205 to the serial interface circuit 304 of the slave processor 30, and performs operation of transferring a storing command for instructing the slave processor 30 to store the control data. In response to the storing command of the control data, the CPU 302 stores the control data in an area of the RAM 301 specified by the command concerned, and generates a control data table (S5). Although not limited in particular, it is assumed here that it is not necessary to transfer to the RAM 301 in advance the control data for initial setting to be set to the SWP communication interface circuit 306, and to generate a table. Although not limited in particular, this is because of the assumption that if initial setting is once performed in the break state, the subsequent change of the setup is not necessary.

Subsequently, when the instruction execution state of the CPU 200 branches to the starting address of the target program of the RAM 207, transition to an emulation operation state (user program executing state) is practiced. In the emulation operation state, when the master processor 20 performs the function setup of the radio frequency communication interface circuit 307 by executing the target program, the master processor 20 performs the setup operation to the command generating circuit 209 in a pseudo manner. The operation which is significant in the command generating circuit 209 in the pseudo setup operation is to instruct a write destination (setup destination). The command generating circuit 209 decodes the information of the write destination to recognize the write destination and generates a command for writing a control data by specifying the write destination and the table previously formed in the RAM corresponding to the write destination. The command generating circuit 209 issues the generated command as a set command of the control data, from the SCI 205 to the SCI 304 of the slave processor 30 via the first communication path 51. The slave processor 30 executes the first evaluation control program FW, and sets the control data specified by the set command of the control data to the control register of the radio frequency communication interface circuit 307 from the control data table of the RAM 301 (S6). In this way, when the master processor 20 executes the target program TPGM to perform data processing for setting the control data to the radio frequency communication interface circuit 307, the processing is reflected in the radio frequency communication interface circuit 307 of the slave processor 30. Accordingly, the master processor 20 can use directly the radio frequency communication interface circuit 307 to which the control data has been reflected, from the GPIO 201 via the second communication path 52 and through the GPIO 300.

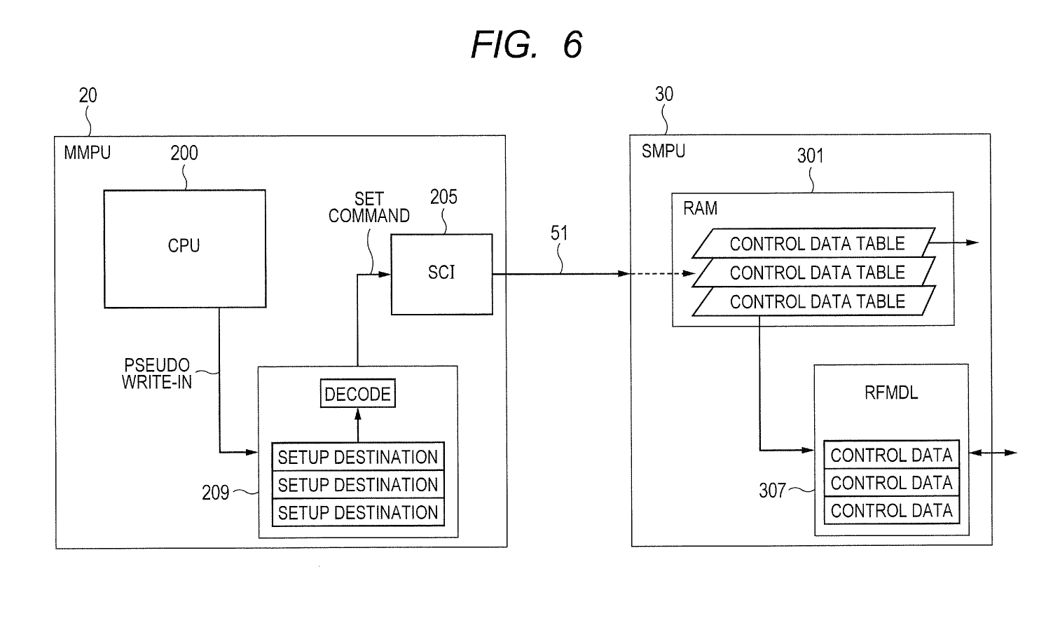

FIG. 6 illustrates the generation operation of the set command in order. When a setup destination of the control data is written in the command generating circuit 209 in a pseudo manner according to the executed result of the target program TPGM, the command generating circuit 209 decodes the setup destination of the control data and issues a set command of the control data to the slave processor 30. Thereby, according to the specification by the set command concerned, the control data is set to a register of the radio frequency communication interface circuit 307 from the table of the RAM 301.

In this way, the control data utilized for a setup of the radio frequency communication interface circuit 307 is transferred to the RAM 301 of the slave processor 30 in advance in the break state, and when the master processor 20 executes processing for changing the operating conditions of the radio frequency communication interface circuit 307 in the emulation operation state in which the target program is executed, the slave processor 30 responding to this selects the corresponding control data from the RAM 301, and sets it to the register of the radio frequency communication interface circuit 307. Accordingly, the setup operation does not involve the interprocessor transfer of the control data from the master processor 20 to the slave processor 30. Therefore, it is possible to enhance the efficiency of the setup change of the operating conditions for the radio frequency communication interface circuit 307 of the slave processor 30 by the master processor 20 for emulation.

In the emulation operation state, the break control circuit 23 monitors the state of the internal bus 206 and the system bus 50. When coincidence with a break condition set up in advance is determined, the break control circuit 23 requests the master processor 20 for a break interrupt. Accordingly, the master processor 20 stops execution of the target program, and shifts to the break state in which controls are performed according to the first evaluation control program FW (S5). In the emulation operation state, data, an address signal, etc. of the internal bus 206 and the system bus 50 are successively stored in the trace circuit 24 in unit of bus cycles, according to the trace condition set up in advance. In the break state, the data, the address signal, etc. are supplied from the emulator controller 22 to the host device 4 and the control operation by the target program is analyzed. In this way, the emulation operation state (S6) and the break state (S5) are repeated alternately, and the target program is executed successively.

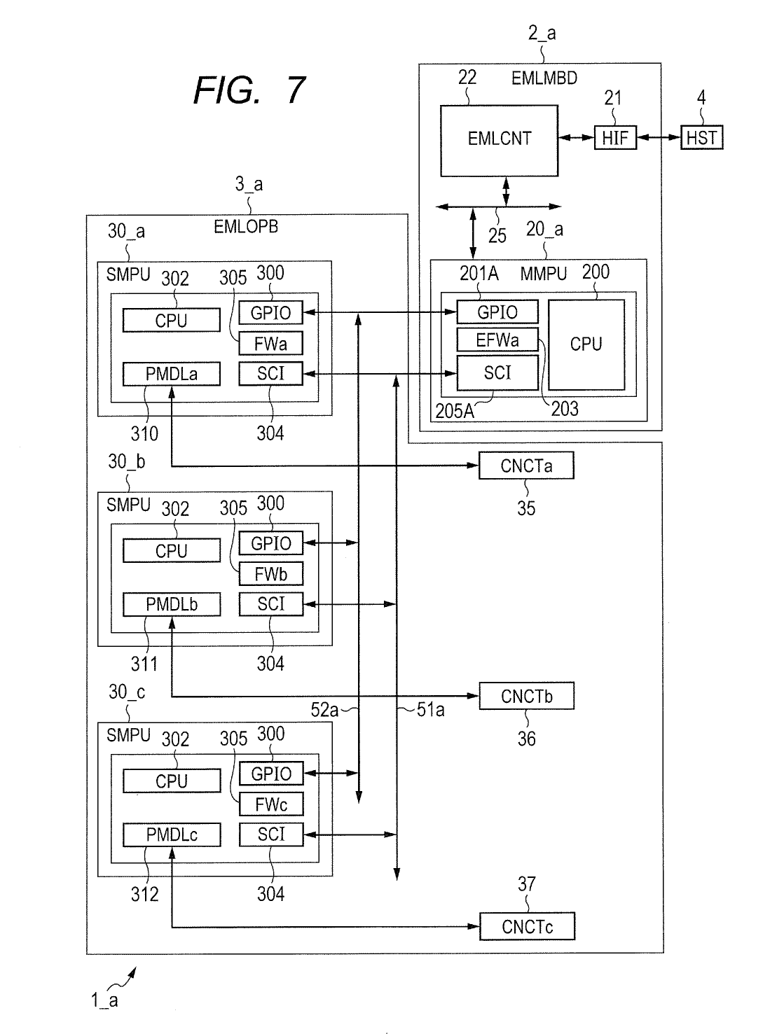

FIG. 7 illustrates another example of the emulator. The emulator 1_{—}a illustrated in FIG. 7 comprises three slave processors 30_{—}a, 30_{—}b, and 30_{—}c. A serial interface 205A of a master processor 20_{—}a is individually coupled to a serial interface 304 of each of the slave processors 30_{—}a, 30_{—}b, and 30_{—}c, via a first communication path 51a. A general-purpose input/output port 201A of the master processor 20_{—}a is individually coupled to a general-purpose input/output port GPIO 300 of each of the slave processors 30_{—}a, 30_{—}b, and 30_{—}c, via a second communication path 52a. When an evaluation interface mode is set up, the slave processors 30_{—}a, 30_{—}b, and 30_{—}c use peripheral circuits 310, 311, and 312, respectively. The peripheral circuits, PMDLa 310, PMDLb 311, and PMDLc 312 are coupled to respectively corresponding connectors, CNCTa 35, CNCTb 36, and CNCTc 37. The master processor 2_{—}a holds a second evaluation control program EFWa, and the slave processors 30_{—}a, 30_{—}b, and 30_{—}c hold first evaluation control programs FWa, FWb, and FWc, respectively. Other configurations are the same as that of the emulator 1 illustrated in FIG. 1 and the same reference symbol is attached to the circuit module which has an identical function, and the detailed explanation thereof is omitted. Although the detailed explanation is omitted in particular, also when the emulation micro-processor is configured by coupling three or more slave processors to the master processor 20_{—}a as illustrated in FIG. 7, the same operation-effect as in FIG. 1 can be obtained.

According to the emulator as explained above, the following operation-effects are obtained.

(1) In the emulator 1 illustrated in FIG. 1, the control data utilized for a setup of the predetermined peripheral circuit 307 is transferred to the RAM 301 of the slave processor 30 in advance in the break state, and when the master processor 20 executes processing for changing the operating conditions of the peripheral circuit in the emulation operation state in which a target program is executed, the slave processor 30 responding to this selects the corresponding control data from the RAM 301, and sets it to the predetermined peripheral circuit 307. Accordingly, the setup operation does not involve the interprocessor transfer of the control data from the master processor 20 to the slave processor 30. Therefore, it is possible to enhance the efficiency of the setup change of the operating conditions for the peripheral circuit 307 of the slave processor 30 by the emulation master processor 20. The same holds for the emulator 1a illustrated in FIG. 7.

(2) As explained with reference to FIG. 1, it is possible to realize the emulation processor by preparing plural peripheral circuits for each of the slave processors 30_1 and 30_2. Similarly as for the emulator illustrated in FIG. 7, it is possible to realize the emulation processor by preparing plural peripheral circuits for each of the slave processors 30_{—}a, 30_{—}b, and 30_{—}c. Accordingly, even when it is difficult to prepare the real chip as a slave processor which mounts plural predetermined peripheral circuits in one chip or when it is possible to prepare such a real chip, it becomes possible to take the measures by the individual slave processor for each peripheral circuit, in cases where there are restrictions of the number of external terminals such that it is difficult to secure external terminals or input/output ports to which the second communication path can be assigned for each predetermined peripheral circuit.

(3) By configuring a master processor with an FPGA-based semiconductor integrated circuit, it is possible to support quickly the change of the peripheral circuit in the emulation processor. By employing a real chip for the slave processor, it is possible to provide easily a peripheral circuit necessary for the emulation processor.

(4) The peripheral circuit of the real chip can be easily utilized as a peripheral circuit of an emulation microcomputer by adopting the evaluation interface mode to the real chip.

(5) By providing a flag i.e., the mode register FEML, which sets up the evaluation interface mode, the evaluation interface mode can be easily set to the slave processor by the master processor, in the break state.

(6) In the selection of the peripheral circuit of the slave processor to be used as a peripheral circuit of the master processor, it is possible to easily select the execution state of a program for employing one peripheral circuit among the first evaluation control programs, by the terminal processing by means of the external terminals P1, P2, and P3.

(7) By employing the emulator illustrated in FIGS. 1 and 4, it is possible to easily support debugging to the system using the single wire protocol interface which interfaces the interface of the proximity non-contact communication with a microcomputer for IC cards.

(8) When the master processor 20 executes the target program to perform the data processing for setting control data to the peripheral circuit of the slave processor 30, the command generating circuit 209, in conjunction with this, generates automatically the command corresponding to the processing, and the slave processor 30 which executes the first evaluation control program FW is enabled to set the control data to the peripheral circuit concerned. Accordingly, it is possible to make the slave processor 30 automatically control the operation that the master processor 20 sets the control data to the RFMDL 307 in the executing state of the target program TPGM. Here, the control data has been transferred to slave processor 30 in advance in order to be utilized for a setup of the RFMDL 307. The operation does not disturb nor impose burden on the executing state of the target program by the master processor 20.

(9) The first evaluation control program FW (FWa, FWb, FWc) is held in the flash memory in a rewritable manner. Accordingly, it is possible to easily support version upgrade and bug patch of these evaluation control programs.

### Embodiment 2

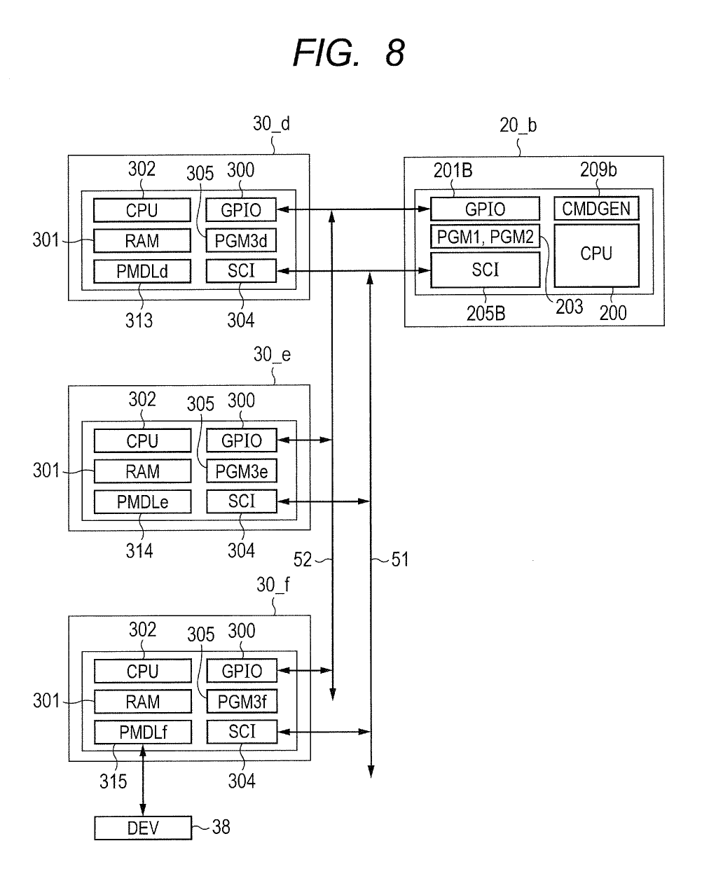

FIG. 8 illustrates a multi-processor system according to another embodiment of the present invention.

The multi-processor system illustrated in FIG. 8 is configured by mounting a first processor 20_{—}b, plural second processors, for example, three second processors 30_{—}d, 30_{—}e, and 30_{—}f, and other devices (DEV) 38 on a mounting board (not shown).

The first processor 20_{—}b comprises a CPU 200 which executes a first program PGM1 and a second program PGM2 stored in an electrically rewritable nonvolatile memory, for example, a flash memory 203B, a general-purpose input/output port (GPIO) 201B illustrated representatively, a command generating circuit (CMDGEN) 209b, and a serial interface circuit (SCI) 205B. The first processor 20_{—}b is formed in a single semiconductor chip not in an FPGA-based semiconductor chip.

The second processors 30_{—}d, 30_{—}e, and 30_{—}f are formed in a single semiconductor chip, respectively, with the same or different configuration mutually. Each of the second processors comprises a CPU 302, a RAM 301, a general-purpose input/output port 300, a flash memory 305, and a serial input/output port 304, which are illustrated representatively. Although not limited here, the second processor 30_{—}d comprises a peripheral circuit (PMDLd) 313, and holds a third program PGM3d in the flash memory 305. Similarly, the second processor 30_{—}e comprises a peripheral circuit (PMDLe) 314, and holds a third program PGM3e in the flash memory 305. The second processor 30_{—}f comprises a peripheral circuit (PMDLf) 315, and has a third program PGM3f in a flash memory 305.

The setting method of the control data for the peripheral circuits 313, 314, and 315 is the same as that of Embodiment 1. That is, the second processor 30_{—}d (30_{—}e, 30_{—}f) executes the third program PGM3d (PGM3e, PGM3f), receives control data and a first command from the first processor 20_{—}b which executes the first program PGM1, via the serial interface circuit 205B, and stores the control data in the RAM 301 according to the first command. When the first processor 20_{—}b performs the function setup of the peripheral circuit 313 (314, 315) according to the second program PGM2, the first processor 20_{—}b issues a second command generated by the command generating circuit 209b to the second processor 30_{—}d (30_{—}e, 30_{—}f) via the first communication path 51. The second processor 30_{—}d (30_{—}e, 30_{—}f) executes the third program PGM3d (PGM3e, PGM3f) to set the control data specified by the second command to the peripheral circuit 313 (314, 315) concerned from the RAM 301. Accordingly, the first processor 20_{—}b uses the peripheral circuit 313 (314, 315) with the control data set up, via the second communication path 52 by means of the second program PGM2.

When the CPU 200 executes the second program PGM2 to perform data processing for the function setup of the predetermined peripheral circuit 313 (314, 315), in response to the data processing, the command generating circuit 209b generates the second command, and outputs it to the first communication path 51 from the serial interface circuit 205B. By adopting the command generating circuit 209b, it is possible to make the second processor 30_{—}d (30_{—}e, 30_{—}f) automatically control the operation for setting the control data to the peripheral circuit 313 (314, 315) concerned, in the system operating state when the first processor 20_{—}b executes the second program PGM2. Here, the control data has been transferred to the second processor 30_{—}d (30_{—}e, 30_{—}f) in advance in order to be utilized for a setup of predetermined peripheral circuit 313 (314, 315). Accordingly, the operation does not disturb nor impose burden on the executing state of the second program PGM2 by the first processor 20_{—}b.

According to the present multi-processor system, the first processor 20_{—}b transfers the control data to be utilized for the setup of the predetermined peripheral circuit 313 (314, 315) to the second processor 30_{—}d (30_{—}e, 30_{—}f) in advance in the control operating state in which the first program PGM1 is executed, and when the first processor 210_{—}b executes processing for changing the operating conditions of the peripheral circuit 313 (314, 315) in the system operating state in which the second program PGM2 is executed, the second processor 30_{—}d (30_{—}e, 30_{—}f) responding to this selects the corresponding control data from the RAM 301, and sets it to the predetermined peripheral circuit 313 (314, 315). Accordingly, the setup operation does not involve the interprocessor transfer of the control data from the first processor 20_{—}b to the second processor 30_{—}d (30_{—}e, 30_{—}f). Therefore, it is possible to enhance the efficiency of the setup change of the operating conditions for the peripheral circuit 313 (314, 315) of the second processor 30_{—}d (30_{—}e, 30_{—}f) by the first processor 20_{—}b, in the system operating state. In short, it is possible to enhance the efficiency of the setup change of the operating conditions for the interior of the other micro-processor 30_{—}d (30_{—}e, 30_{—}f) by one micro-processor 20_{—}b in the multi-processor system.

As described above, the invention accomplished by the present inventors has been concretely explained based on the embodiments. However, it cannot be overemphasized that the present invention is not restricted to the embodiments, and it can be changed variously in the range which does not deviate from the gist.

For example, the master processor is not restricted to an FPGA type. The circuit configuration of the master processor and the slave processor and the kind of peripheral circuit provided therein can be changed suitably. The evaluation interface mode may be selected by means of the terminal processing. Selecting one peripheral circuit from plural on-chip peripheral circuits may not be restricted to the selection by a register, but may be performed by means of the terminal processing. Plural on-chip peripheral circuits formed in one slave processor may be selected and diverted as the peripheral circuits of the master processor. The interface circuit employed for the transfer of control data and the transfer of a command is not restricted to a serial interface circuit, however, it is also possible to adopt a parallel interface in the range of restrictions of the number of external terminals.

What is claimed is:

1. An emulator comprising:
an emulator controller interfaced with a host device;
a master processor; and
a slave processor, the master processor and the slave processor configuring an emulation processor coupled to the emulator controller,
wherein the slave processor comprises:
a predetermined peripheral circuit which is not provided in the master processor,
wherein the slave processor executes a first evaluation control program to receive control data and a first command via a first communication path from the master processor executing a second evaluation control program, and stores the control data in a predetermined storage area in accordance with the first command,
wherein the master processor issues a second command to the slave processor via the first communication path, when executing a target program to perform function setup of the peripheral circuit,
wherein the slave processor executes the first evaluation control program to set up control data specified by the second command, to the peripheral circuit from the storage area, and
wherein the master processor executes the target program and uses the peripheral circuit set up with the control data, via a second communication path.

2. The emulator according to claim 1,
wherein the master processor is comprised of a first CPU for realizing a necessary program control function and an FPGA-based semiconductor integrated circuit with logical function to be controlled by the first CPU being set reconfigurably.

3. The emulator according to claim 2,
wherein the slave processor is a single-chip semiconductor processor comprised of a second CPU having identical function as the first CPU of the master processor, and the predetermined peripheral circuit.

4. The emulator according to claim 1,
wherein the slave processor has an evaluation interface mode which makes the peripheral circuit accessible from the exterior of the slave processor via the second communication path.

5. The emulator according to claim 4, further comprising:
a mode register operable to set up the evaluation interface mode,
wherein the master processor issues setup data and a third command to the slave processor via the first communication path, when setting up the mode register by means of the second evaluation control program, and
wherein the slave processor executes the first evaluation control program to set the setup data specified by the third command to the mode register.

6. The emulator according to claim 4,
wherein the slave processor comprises a plurality of peripheral circuits, and one of the peripheral circuits selected is made accessible from the exterior of the slave processor in the evaluation interface mode.

7. The emulator according to claim 6,
wherein the slave processor selects a program to be executed at the time of cancelation of a reset, according to a state of a predetermined external terminal, and
wherein a first state of the external terminal is a state of instructing execution of a program for employing one peripheral circuit in the first evaluation control program.

8. The emulator according to claim 6,
wherein the slave processor comprises, as the peripheral circuit:
a first communication interface circuit operable to perform proximity non-contact communications through an antenna coupled externally; and
a second communication interface circuit operable to interface the first communication interface circuit with an IC card microcomputer by means of a single wire protocol.

9. The emulator according to claim 1,
wherein the master processor comprises:
a first CPU operable to execute the second evaluation control program and the target program;
a first interface circuit coupled to the first communication path; and
a command generating circuit operable to generate the second command in response to the data processing performed by the first CPU for function setup of the predetermined peripheral circuit by executing the target program, and operable to output the generated second command to the first communication path from the first interface circuit,
wherein the slave processor comprises:
a second CPU operable to execute the first evaluation control program; and
a second interface circuit coupled to the first communication path, and
wherein the second CPU executes the first evaluation control program to perform the data processing for responding a command received in the second interface circuit.

10. The emulator according to claim 9,
wherein the master processor comprises:
a nonvolatile memory operable to hold the second evaluation control program in a rewritable manner; and
a volatile memory operable to hold the target program in a rewritable manner, and
wherein the slave processor comprises:
a nonvolatile memory operable to hold the first evaluation control program in a rewritable manner.

11. The emulator according to claim 1, further comprising:
a plurality of the slave processors,
wherein each of the slave processors executes a respectively unique first evaluation control program, and is controlled by the master processor which executes the second evaluation control program and the target program.

12. A multi-processor system comprising:
a first processor operable to execute a first program and a second program; and
a second processor provided with a peripheral circuit and operable to execute a third program,
wherein the second processor executes the third program to receive control data and a first command via a first communication path from the first processor executing the first program, and stores the control data in a predetermined storage area in accordance with the first command,
wherein the first processor issues a second command to the second processor via the first communication path, when performing function setup of the peripheral circuit by means of the second program,
wherein the second processor executes the third program to set the control data specified by the second command to the peripheral circuit from the storage area, and
wherein the first processor uses the peripheral circuit with the control data set up via a second communication path by means of the second program.

13. The multi-processor system according to claim 12,
wherein the first processor comprises:
a first CPU operable to execute the first program and the second program;
a first interface circuit coupled to the first communication path; and
a command generating circuit operable to generate the second command in response to the data processing performed by the first CPU for function setup of the predetermined peripheral circuit by executing the second program, and operable to output the generated second command to the first communication path from the first interface circuit,
wherein the second processor comprises:
a second CPU operable to execute the third program; and
a second interface circuit coupled to the first communication path, and
wherein the second CPU executes the third program to perform the data processing for responding a command received in the second interface circuit.

14. The multi-processor system according to claim 13,
wherein the first processor comprises:
a nonvolatile memory operable to hold the first program in a rewritable manner, and
wherein the second processor comprises:
a nonvolatile memory operable to hold the third program in a rewritable manner.

15. The multi-processor system according to claim 12, further comprising:
a plurality of the second processors,
wherein each of the second processors executes a respectively unique third program, and is controlled by the first processor which executes the first program and the second program.
